(19) United States
(12) Patent Application Publication
(10) Pub. No.: US 2014/0213706 A1
(43) Pub. Date: Jul. 31, 2014

(54) UNVULCANIZED RUBBER COMPOSITION FOR CALENDARING AND METHOD FOR MANUFACTURING TOPPING RUBBER USING THE SAME

(71) Applicant: Sumitomo Rubber Industries, Ltd., Kobe-shi (JP)

(72) Inventor: Shinichiro HONDA, Kobe-shi (JP)

(73) Assignee: Sumitomo Rubber Industries, Ltd., Kobe-shi (JP)

(21) Appl. No.: 14/147,933

(22) Filed: Jan. 6, 2014

(30) Foreign Application Priority Data
Jan. 25, 2013 (JP) 2013-012507

(51) Int. Cl. C08L 7/00; B29D 30/06; C08K 13/02

(52) U.S. Cl. CPC C08L 7/00; C08K 13/02; B29D 30/0681
USPC 524/186; 264/175

(57) ABSTRACT

An unvulcanized rubber composition for calendaring has an elongational viscosity of not more than 102 kPa when measured at a temperature of 95 deg. C., and a shear velocity of 500 to 2000 (1/second). A method for manufacturing a topping rubber for a cord ply embedded in a pneumatic tire is characterized in that, the unvulcanized rubber composition is extended and shaped with the use of calender rolls whose surface temperature is 60 to 100 deg. C.

### BACKGROUND OF THE INVENTION

The present invention relates to an unvulcanized rubber composition having superior processability during calendaring and a method for manufacturing a topping rubber using the same.

In recent years, vehicle tires are required to have various performances helpful for environmental conservation, e.g. lower fuel consumption, longer tire life time and the like.

In the meantime, a pneumatic tire is reinforced by tire cords, e.g. carcass cords, belt cords and the like, and such cords are coated with a topping rubber.

The vulcanized topping rubber largely affects the above-mentioned various performances.

A typical method for coating such tire cords with unvulcanized topping rubber is a calendering using calender rolls.

In the rubber industry, Mooney viscosity of an unvulcanized rubber composition is widely used as a measure of processability of the unvulcanized rubber composition. (cf. JIS K6300 “Physical Testing Methods For unvulcanized Rubber” for example).

Heretofore, an unvulcanized rubber composition whose Mooney viscosity is high is considered as being poor in processability.

However, as a result of a number of experiments made by the present inventor, it was found that, in the case of calendering, Mooney viscosity is not always a proper measure of the processability.

Concretely speaking, in a topping process in which an unvulcanized topping rubber composition stretched by calender rolls is applied to an array of cords, a rubber composition (A) applied cracks and the cords are exposed, but another rubber composition (B) applied does not crack and the cords are completely covered although the Mooney viscosity of the rubber composition (B) is higher than that of the rubber composition (A).
Thus, it is not proper to use the Mooney viscosity only as a measure of the processability of an unvulcanized rubber composition in the case of calendering using calender rolls.

The present inventor found out that, rather than Mooney viscosity, the use of elongational viscosity is appropriate as a measure of the processability of an unvulcanized rubber composition for calendaring which is subjected to elongation deformation by calender rolls. Further, the values of elongational viscosity suitable for calendering were found out and, based on that, the present invention was accomplished.

### SUMMARY OF THE INVENTION

It is therefore, an object of the present invention to provide an unvulcanized rubber composition for calendaring and a method for manufacturing a topping rubber using the same, in which an elongational viscosity of the unvulcanized rubber composition measured under specific measuring conditions is limited in a specific range, and the processability during calendaring is improved.

According to the present invention, an unvulcanized rubber composition for calendaring during which the unvulcanized rubber composition is subjected to elongation deformation by calender rolls and which is characterized by having

an elongational viscosity of not more than 102 kPa when measured at a temperature of 95 deg. C., and a shear velocity of 500 to 2000(1/second).

Preferably, the elongational viscosity is not less than 2 kPa. The unvulcanized rubber composition is suitably used as topping rubber for a cord ply embedded in a pneumatic tire. The cord ply can be a tread reinforcing belt ply embedded in a tread portion of the pneumatic tire. The unvulcanized rubber composition may comprise: base rubber including 55 to 100 parts by weight of natural rubber and 45 to 0 parts by weight of isoprene rubber; and 40 to 60 parts by weight of carbon black with respect to 100 parts by weight of the base rubber.

According to the present invention, a method for manufacturing a topping rubber for a cord ply embedded in a pneumatic tire, comprises a step of extending and shaping the unvulcanized rubber composition as set forth in any one of claims 1-5 with the use of calender rolls whose surface temperature is 60 to 100 deg. C. so that the unvulcanized rubber composition is shaped into the topping rubber within a temperature range of from 60 to 140 deg. C.

Therefore, the unvulcanized rubber composition has improved processability and can be thinly and fully stretched through calendering. Thus, the production efficiency can be increased.

### BRIEF DESCRIPTION OF THE DRAWING

FIG. 1 is a cross sectional view of a capillary rheometer for measuring the elongational viscosity.

### DESCRIPTION OF THE PREFERRED EMBODIMENTS

Embodiments of the present invention will now be described in detail in conjunction with the accompanying drawings.

According to the present invention, an unvulcanized rubber composition for calendaring is based on that it is subjected to elongation deformation by calender rolls, and characterized by having an elongational viscosity of not more than 102 kPa when measured at a temperature of 95 deg. C. and a shear velocity of 500 to 2000 (1/second).

Mooney viscosity, which is heretofore used as a measure of the processability of an unvulcanized rubber composition, is defined as the shearing torque resisting rotation of a cylindrical metal disk (or rotor) embedded in rubber within a cylindrical cavity as specified by JIS-K6300.

However, in the process of calendering, the deformation which the unvulcanized rubber composition mainly receives when passing through the gap between calender rolls is elongation deformation rather than shearing deformation.

Usually, the shearing deformation is accompanied by elongation as well as torsion. In such case, the rubber composition shows non-Newtonian behavior and the viscosity decreases with the deformation rate or velocity is increased.

In the case of the elongation deformation, on the other hand, depending on the kind of the macromolecular, there is a possibility that the viscosity shows a steep increase when the stretch of the molecular chains approaches the limits.

Accordingly, if only the mechanical behavior of an unvulcanized rubber composition when subjected to shearing deformation is observed in order to evaluate the processability of the unvulcanized rubber composition during calendering, the considered is only one side of the flow property of the unvulcanized rubber composition in the calendering process. Thus, this is not enough.

The inventor found that, rather than Mooney viscosity, elongational viscosity is an important factor in order to accurately evaluate the processability of an unvulcanized rubber composition during calendering, and that, by limiting the elongational viscosity within a specific range, processing defects such as rubber crack and the like possibly occurring in the calendering, especially, topping process, can be reduced.

The elongational viscosity is measured under the following measuring conditions: the temperature of the unvulcanized rubber composition is 95 deg. C., and the shear velocity is 500 to 2000 (1/second).

In order to measure, a capillary rheometer is used. Preferably used is a twin capillary rheometer 1 based on the twin bore measurement principle (for example, RH7-D & RH10-D CAPILLARY RHEOMETERS).

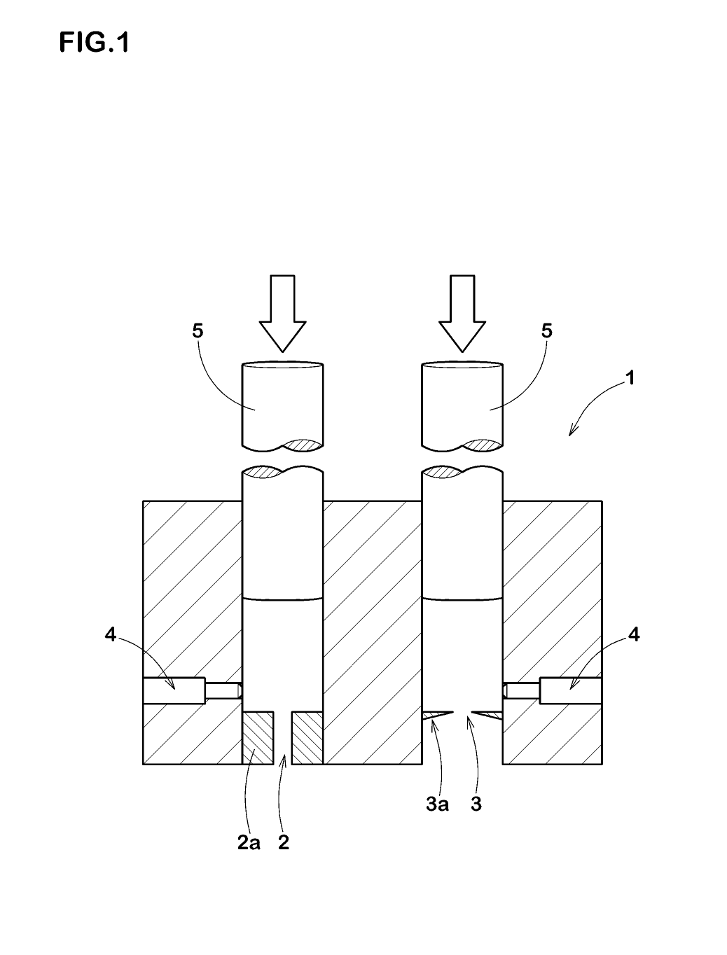

As shown in FIG. 1, this type of capillary rheometer 1 comprises a long capillary tube 2 formed by a longer die 2a, a short capillary tube 3 formed by a shorter die 3a, two pressure transducers 4, and two pistons 5.

In order to obtain the value of the elongational viscosity from the data obtained by the capillary rheometer, the Bagley correction needs to be performed based on two different capillary tube lengths, and then the elongational viscosity is calculated using the Cogswell method.

Therefore, by using a twin capillary rheometer, the measurements with respect to two different capillary tube lengths can be made simultaneously, and the efficiency as well as the accuracy of the measurement is improved.

Incidentally, the Bagley correction is described in “1961 vol. 5 no. 1 P 355-368 Trans. soc. Rheol. Bagley E. B. The separation of elastic and viscous effects in polymer flow”.

The Cogswell method is described in “1972 vol. 12 P 64-73 Polym. Eng. Sci. Cogswell F. N. converging flow of polymer melts in extrusion dies”.

As the stretch of the flowing rubber composition is caused at the inlet of the die where the flow channel becomes narrow, The elongational viscosity λ can be obtained from the following equation (1):

λ={9(n+1)̂2×P̂2}/(32η×γ) (1)

wherein
n is the power index of the power law fluid,
P is the pressure at the die inlet,
η is the shear viscosity, and
γ is the shear velocity,

when a topping process is performed by the use of a pair of calender rolls, a typical temperature of the unvulcanized rubber composition is 60 to 100 deg. C.

If the temperature is high, there is a possibility that vulcanization starts partially and the quality is decreased. If the temperature is low, the viscosity is increased and there is a possibility that necessary processability for the rubber can not be obtained.

According to the present invention, in view of the processability, a relatively higher temperature of 95 deg. C. was selected from the typical temperature range, and the elongational viscosity of the unvulcanized rubber composition is defined as measured at 95 deg. C.

In order that the unvulcanized rubber composition has the most suitable processability for calendaring, the elongational viscosity under the above-mentioned measuring conditions is set in a range of not more than 102 kPa and preferably not less than 2 kPa.

If more than 102 kPa, it becomes difficult to stretch the unvulcanized rubber composition as desired during calendering, and cracks become liable to occur. If less than 2 kPa, it becomes difficult to stretch the unvulcanized rubber composition into a continuous sheet or film, namely, the sheet is liable to break.

According to the present invention, as far as the elongational viscosity satisfies the above-mentioned limitation, the unvulcanized rubber composition is not limited to a specific composition. But, in the case of the topping rubber for the belt cords of a tread reinforcing belt which is disposed radially outside the carcass in the tread portion of a pneumatic tire, it is preferable that the unvulcanized rubber composition comprises: base rubber including 55 to 100 parts by weight of natural rubber, and 45 to 0 parts by weight of isoprene rubber; and with respect to 100 parts by weight of the base rubber, 40 to 60 parts by weight carbon black, and preferably, 5 to 10 parts by weight of oil.

The unvulcanized rubber composition is extended and shaped by the use of calender rolls whose surface temperature is 60 to 100 deg. C. In this case, there is a possibility that the temperature of the extended and shaped unvulcanized rubber composition is increased above the surface temperature by the resultant shear heat generation. Even in such case, the temperature of the unvulcanized rubber composition is controlled within a range of from 60 to 140 deg. C.

The elongational viscosity of the unvulcanized rubber composition can be controlled by

changing the linearity of the polymer (namely, the rate of branched chains in the macromolecular),
changing the ratio between the content of carbon black and that of natural rubber,
changing the ratio of the content of SBR and that of silica coupling agent, and/or adding a small amount of an ultrahigh molecular weight component into the rubber composition.

Further, in the process of manufacturing the rubber composition, the elongational viscosity can be controlled within the above-mentioned range by changing the diameters of the calender rolls, the gap between the calender rolls, the friction ratio, the frictional coefficient, and/or the shape and material of the surface of the calender roll.

The rubber compositions heretofore used for the tire cords may be used as the basis of the unvulcanized rubber composition according to the present invention, premised on that the elongational viscosity is controlled within the above-mentioned range as explained above.

### Comparison Tests

In order to confirm the effects of the invention, unvulcanized rubber compositions shown in Table 1 were prepared. In order to prepare each composition, firstly, the materials excluding sulfur and vulcanizing accelerator were kneaded for 5 minutes at about 150 deg. C. with the use of a banbury mixer. Then, the sulfur and vulcanizing accelerator were added thereto and all of the materials were further kneaded for 5 minutes at a temperature of 80 deg. C. with the use of a twin roll open mill.

The unvulcanized rubber compositions (for topping rubber of a tire belt ply) prepared as above were measured and tested as follows.

### <Mooney Viscosity>

According to the Japanese Industrial Standard K6300, the Mooney viscosity of the unvulcanized rubber composition was measured at a temperature of 130 deg. C.
The results are indicated in Table 1 by an index based on comparative example Ref. 1 being 100, wherein the larger the index number, the lower the Mooney viscosity.

### <Elongational Viscosity>

The elongational viscosity of the unvulcanized rubber composition at a temperature of 95 deg. C, and a shear velocity of 1000(1/second) was measured with the use of a twin capillary rheometer “Rosand RH-7” manufactured by Malvern Instruments Ltd. (longer die length 16 mm, longer die diameter 1.0 mm, shorter die length 0.25 mm, shorter die diameter 1.0 mm, die inlet angle 180 degrees, Pressure transducer NP467XL, Dynicos).

### <Complex Elastic Modulus and Loss Tangent>

The unvulcanized rubber composition was vulcanized at a temperature of 170 deg. C. for 12 minutes. Then, the vulcanized rubber was measured for the complex elastic modulus (E*) at a temperature of 70 deg. C., a frequency of 10 Hz, an initial strain of 10%, and a dynamic strain of 1%, by the use of a viscoelastic spectrometer VES manufactured by Iwamoto seisakusyo.

Further, the loss tangent of the vulcanized rubber was measured at a temperature of 60 deg. C. The other measuring conditions were the same as above.

The results are indicated in Table 1 by an index based on comparative example Ref. 1 being 100.

The larger the index number, the better the rigidity.
The larger the index number, the smaller the loss tangent.
<Workability during Calendering>
When the unvulcanized rubber composition was shaped into a sheet by passing through between calender rolls having a surface temperature of 65 deg. C., it was visually checked whether crack was caused or not.
The results are shown in Table 1, wherein
“G” means that no crack was caused, and
“B” means that crack or breakage was caused.

### <Wear Resistance>

With respect to each of the unvulcanized rubber compositions, pneumatic tires (size 195/65R15) whose tread rubber and belt cord topping rubber were formed from the same unvulcanized rubber composition, were experimentally manufactured.
After running for 8000 km by the use of a test car, the depth of tread grooves was measured to know the tread wear.
The running distance required for the tread wear of 1 mm was calculated as the wear resistance.
The results are indicated in Table 1 by an index based on comparative example Ref. 1 being 100, wherein the larger the index number, the higher the wear resistance.

From the test results, it was confirmed that the unvulcanized rubber compositions according to the present invention were improved in the processability during calendering.

TABLE 1

| | Ref.1 | Ref.2 | Ex.1 | Ex.2 | Ex.3 | Ex.4 | Ex.5 | Ex.6 |
|---|---|---|---|---|---|---|---|---|
| natural rubber | 100 | 100 | 80 | 70 | 100 | 60 | 100 | 100 |
| isoprene rubber | — | — | 20 | 30 | — | 40 | — | — |
| carbon black | 60 | 60 | 60 | 60 | 50 | 60 | 40 | 50 |
| aromatic oil | 5 | 10 | 5 | 5 | 5 | 5 | 5 | 10 |
| age resistor | 2 | 2 | 2 | 2 | 2 | 2 | 2 | 2 |
| zinc oxide | 10 | 10 | 10 | 10 | 10 | 10 | 10 | 10 |
| sulfur | 8 | 8 | 8 | 8 | 8 | 8 | 8 | 8 |
| vulcanizing accelerator TBBS | 1 | 1 | 1 | 1 | 1 | 1 | 1 | 1 |
| cobalt metal salt | 1 | 1 | 1 | 1 | 1 | 1 | 1 | 1 |
| Mooney viscosity | 87 | 80 | 100 | 92 | 82 | 88 | 72 | 77 |
| elongational viscosity (kPa s) | 118 | 109 | 102 | 96 | 101 | 97 | 93 | 88 |
| complex elastic modulus | 100 | 92 | 89 | 85 | 93 | 74 | 75 | 70 |
| loss tangent | 100 | 102 | 98 | 97 | 96 | 95 | 96 | 85 |
| processability in calendering | B | B | G | G | G | G | G | G |
| wear resistance | 100 | 103 | 97 | 96 | 94 | 94 | 89 | 88 |

Natural rubber: RSS#3
Isoprene rubber: Nipol IR2200, ZEON Corporation
Carbon black: SHOBLACK N220 (N2SA:125 m 2/g), Cabot Japan, Inc.
Aromatic oil: JOMO process X140, Japan Energy Corporation
Age resistor: NOCRACK 6C, OUCHI SHINKO Chemical Industrial Co., Ltd. (chemical name: N-(1,3-dimethyl butyl)-N′-phenyl-p-phenylenediamine)
Zinc oxide: hydrozincite #1, Mitsui Mining & Smelting Co., Ltd.
Cobalt metal salt: cobalt stearate (cobalt content 10%), DIC Corporation
Sulfur: powdered sulfur, Tsurumi Chemical Industry Co., Ltd.
Vulcanizing accelerator TBBS: NOCCELER NS, OUCHI SHINKO Chemical Industrial Co.,Ltd. (chemical name: N-tert-butyl-2-benzothiazolyl sulfenamide)

1. An unvulcanized rubber composition for calendaring during which the unvulcanized rubber composition is subjected to elongation deformation by calender rolls and which is characterized by having an elongational viscosity of not more than 102 kPa when measured at a temperature of 95 deg. C., and a shear velocity of 500 to 2000(1/second).

2. The unvulcanized rubber composition according to claim 1, wherein the elongational viscosity is not less than 2 kPa.

3. The unvulcanized rubber composition according to claim 1 which is used as topping rubber for a cord ply embedded in a pneumatic tire.

4. The unvulcanized rubber composition according to claim 3, wherein the cord ply is a tread reinforcing belt ply embedded in a tread portion of the pneumatic tire.

5. The unvulcanized rubber composition according to claim 1 which comprises: base rubber including 55 to 100 parts by weight of natural rubber and 45 to 0 parts by weight of isoprene rubber; and 40 to 60 parts by weight of carbon black with respect to 100 parts by weight of the base rubber.

6. A method for manufacturing a topping rubber for a cord ply embedded in a pneumatic tire, comprising a step of extending and shaping the unvulcanized rubber composition as set forth in claim 1 with the use of calender rolls whose surface temperature is 60 to 100 deg. C. so that the unvulcanized rubber composition is shaped into the topping rubber within a temperature range of from 60 to 140 deg. C.

7. The unvulcanized rubber composition according to claim 2 which is used as topping rubber for a cord ply embedded in a pneumatic tire.

8. The unvulcanized rubber composition according to claim 2 which comprises: base rubber including 55 to 100 parts by weight of natural rubber and 45 to 0 parts by weight of isoprene rubber; and 40 to 60 parts by weight of carbon black with respect to 100 parts by weight of the base rubber.

9. The unvulcanized rubber composition according to claim 3 which comprises: base rubber including 55 to 100 parts by weight of natural rubber and 45 to 0 parts by weight of isoprene rubber; and 40 to 60 parts by weight of carbon black with respect to 100 parts by weight of the base rubber.

10. The unvulcanized rubber composition according to claim 4 which comprises: base rubber including 55 to 100 parts by weight of natural rubber and 45 to 0 parts by weight of isoprene rubber; and 40 to 60 parts by weight of carbon black with respect to 100 parts by weight of the base rubber.

11. A method for manufacturing a topping rubber for a cord ply embedded in a pneumatic tire, comprising a step of extending and shaping the unvulcanized rubber composition as set forth in claim 2 with the use of calender rolls whose surface temperature is 60 to 100 deg. C. so that the unvulcanized rubber composition is shaped into the topping rubber within a temperature range of from 60 to 140 deg. C.

12. A method for manufacturing a topping rubber for a cord ply embedded in a pneumatic tire, comprising a step of extending and shaping the unvulcanized rubber composition as set forth in claim 3 with the use of calender rolls whose surface temperature is 60 to 100 deg. C. so that the unvulcanized rubber composition is shaped into the topping rubber within a temperature range of from 60 to 140 deg. C.

13. A method for manufacturing a topping rubber for a cord ply embedded in a pneumatic tire, comprising a step of extending and shaping the unvulcanized rubber composition as set forth in claim 4 with the use of calender rolls whose surface temperature is 60 to 100 deg. C. so that the unvulcanized rubber composition is shaped into the topping rubber within a temperature range of from 60 to 140 deg. C.

14. A method for manufacturing a topping rubber for a cord ply embedded in a pneumatic tire, comprising a step of extending and shaping the unvulcanized rubber composition as set forth in claim 5 with the use of calender rolls whose surface temperature is 60 to 100 deg. C. so that the unvulcanized rubber composition is shaped into the topping rubber within a temperature range of from 60 to 140 deg. C.
